(19) United States
(12) Patent Application Publication
(10) Pub. No.: US 2008/0079344 A1
(43) Pub. Date: Apr. 3, 2008

(54) Spark plug and method of securing the mutual positioning of the body of the ceramic insulator with through central electrode and the thermally and electrically conductive casing with lateral electrode of the spark plug

(75) Inventor: Petr Zalud, Plana nad Luznici (CZ)

Correspondence Address: BUCHANAN, INGERSOLL & ROONEY PC, POST OFFICE BOX 1404, ALEXANDRIA, VA, 22313-1404, US

(73) Assignee: BRISK Tabor a.s., Tabor (CZ)

(21) Appl. No.: 11/727,576

(22) Filed: Mar. 27, 2007

(30) Foreign Application Priority Data
Oct. 3, 2006 (CZ) PV 2006-622

(51) Int. Cl. H01T 13/20

(52) U.S. Cl. 313/143

(57) ABSTRACT

A spark plug for a combustion engine comprises a thermally and electrically conductive metal casing with attachment means, in the cavity of which there is a ceramic insulator with central electrode against which, to create the spark gap of the spark plug, there is arranged a lateral electrode fixed to the casing. According to a method, the mutual positioning of the body of the ceramic insulator and the thermally and electrically conductive casing with a lateral electrode of the spark plug, against the thrust of the body of the ceramic insulator from the cavity in the casing at its outer end, opposite the spark gap, is secured by bending the radial shoulder on the front surface of the casing at its outer end into contact with the outer shoulder of the insulator.

### FIELD OF THE INVENTION

The invention involves an arrangement of a spark plug for piston combustion engines, particularly the construction of the metal casing of the spark plug and its attachment to the ceramic insulator.

### DESCRIPTION OF THE PRIOR ART

A spark plug for a piston combustion engine consists of a metal casing with a thread at one end by which the plug is secured to the cylinder head of the combustion engine, and of a cylindrical electric insulating part which is inserted into the steel casing, providing insulation for the high voltage generated. A metal pin, to which the central electrode of the plug is attached, passes through this insulator. A lateral ground electrode, placed in the combustion space of the engine during assembly of the plug, is firmly connected conductively and mechanically to the metal casing and its operating part is generally positioned above the central electrode. The vast majority of spark plugs today have a metal casing consisting, in principle, of the following structural elements: a threaded plug, a sealing surface (for a sealing washer or conical surface) an assembly hexagon and a deformational rim projecting in the axial direction by which the sealing surface is pressed into the adjacent surface of the ceramic insulator. These elements are arranged in the aforementioned order, starting from the side of the combustion space. The conical sealing washer, which is positioned directly on the tip of the insulator and is critical for conducting heat from the tip of the insulator into the metal casing, secures the sealing ceramic insulator in the metal casing on the conical surface at an angle of less than 60°. By varying the length of the tip of the ceramic insulator it is also possible to change the temperature of the plug.

Besides this conventional spark plug structure, there are also plugs with ceramic insulators attached and sealed in the metal casing, with characteristic slim threaded pin connecting to the combustion space, with a sealing cone, a recess for electro-thermal assembly, a thread and an assembly hexagon. This solution has many advantages. Thus, for example, the small end diameter of the casing extending into the combustion space of the engine makes possible more generous dimensioning of the head of the combustion engine, for example of the diameter of the valves, of the cooling space etc. By removing the thread from this area it is possible, with the same outer diameter, to reinforce the wall of the casing or the wall of the ceramic insulator and thus to increase the plug's mechanical or dielectric resistance. The thread on the casing is located after the sealing cone and protects it against high temperatures and sedimentation occurring during defective combustion which, in classic spark plugs, can impede the dismantling and installation of the spark plug in the engine head. The thread is formed on the larger diameter, which produces greater resistance in the plug to damage to the thread on the plug or in the engine head. Unlike the classic plug, when the spark plug wears out there is no reduction in the assembly prestress between the casing and the insulator but, on the contrary, there is a desirable increase. A disadvantage, however, is the constant increase in the length of the plug. The goal of the present invention is to eliminate this disadvantage, at least in part.

There are similar solutions but they show fundamental differences in the method of assembly, in the use of materials, the number of parts and the structure of the connecting parts of the spark plug. For example, a spark plug structure is known in which the metal casing is divided, consisting of an outer part with attaching hexagon and thread, into which is inserted an inner part with the grounded part of the spark gap. These two parts are joined by pressing against the bevelled surface of the ceramic insulator (U.S. Pat. No. 5,697,334). This arrangement is more complicated to manufacture and is unsuitable for a spark plug with a higher heat value, since the sealing part of the metal casing, which at the same time conducts away a critical portion of the heat from the tip of the ceramic insulator extending into the combustion space of the cylinder of the combustion engine, is relatively far from that tip.

### SUMMARY OF THE INVENTION

The subject of this invention is the arrangement of a spark plug for a combustion engine, comprising a thermally and electrically conductive metal casing with attachment means, in the cavity of which there is a ceramic insulator with central electrode against which, to create the spark gap of the spark plug, there is arranged a lateral electrode fixed to the casing where, on the front surface of the outer end of the casing opposite the spark gap, near the edge of its inner opening, there is a radial shoulder adjacent to the corresponding outer shoulder of the insulator in order to fix their mutual positions and their mutual, gas-tight positioning on the opposite, inner end of the casing near the spark gap.

The basis of this invention lies in the fact that, in the area of the base of the radial shoulder, a radial groove is formed in the front surface of the outer end of the casing, making it possible to bend the projection with radial shoulder so formed in the direction of the axis of the spark plug, so that the camber of the bent projection above the front surface of the outer end of the casing is from 0 to 1 mm. The radial shoulder can have a triangular cross-section about 0.3 to 0.6 mm in height with walls at an angle of 40 to 60°, the size of the base being from 0.4 to 1 mm. The casing can advantageously consist of a single integral part.

The subject of this invention is further a method of securing the mutual positioning of the body of the ceramic insulator with through central electrode and the thermally and electrically conductive casing with lateral electrode of the spark plug, against the thrust of the body of the ceramic insulator from the cavity in the casing at its outer end, opposite the spark gap, by bending the radial shoulder on the front surface of the casing at its outer end into contact with the outer shoulder of the insulator. The basis of the invention lies in the fact that, on the front surface of the casing at its outer end, a radial shoulder is formed at its inner opening, with at least a slanted outer lateral side, the slanted side is then subjected to pressure from the radial sharp edge of the pressing instrument, whereby the casing is centred with respect to the axis of the ceramic insulator inserted therein and with respect to the pressing instrument, and then pressure is exerted on the radial sharp edge of the pressing instrument until a radial groove is formed in the front surface of the casing, in the area of the base of the radial shoulder, whereby the radial projection of the casing is formed and at the same time, under the pressure of the obliquely shaped part of the radial sharp edge of the pressing instrument, the downward pressure gradually increases from the outer side on the lateral wall of that projection, until that radial projection bends across the shoulder of the ceramic insulator in the direction of its axis, whereby the casing is secured against the thrust on that end from the spark plug gap. After bending, the radial projection can have a wall about 0.5 to 1 mm in length, ending in a triangular cross-section.

The advantage of this invention is that the insulating distance between the central pin of the plug and the casing is extended (by about 2 mm), while preserving the dimensions of the spark plug. Resistance of the plug against undesirable vaulting of the electrical spark along the surface of the ceramic insulator is thereby increased. This is important in situations where there is a surge in the arcing voltage across the spark gap, for example in supercharged and gas-powered engines, or where moisture or dirt accumulates on the surface of the insulator.

### BRIEF DESCRIPTION OF THE DRAWINGS

An example of an embodiment of the spark plug according to this invention is illustrated in the attached drawings.

FIG. 1 shows the whole arrangement of the spark plug in partial cross-section;

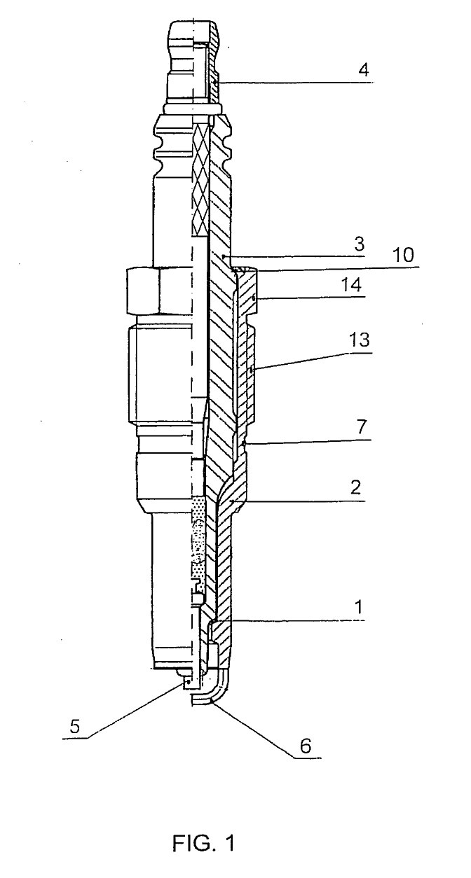

FIGS. 2, 3 and 4 illustrate, in time sequence, the procedure for securing the mutual positioning of the body of the ceramic insulator of the spark plug with through central electrode and the thermally and electrically conductive casing with lateral electrode of the spark plug, against the thrust of the body of the ceramic insulator from the cavity in the casing at its outer end.

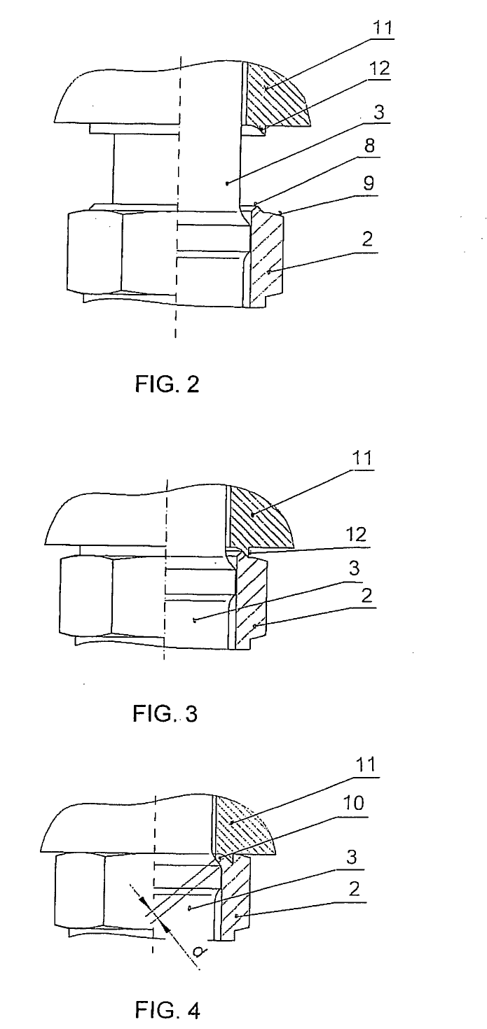

### EXAMPLES OF PREFERRED EMBODIMENTS

The spark plug comprises a thermally and electrically conductive steel casing 2 with attachment means (outer thread 13 of the casing 2 and hexagon 14 for mounting the plug in the engine head). In the cavity of the casing 2 there is a gas-tight ceramic insulator 3 with through central electrode 5 made of AgNi10 alloy. A bent outer lateral electrode 6, made of NiCr2MnSi alloy and connected to the casing 2, fits tightly against the tip of the central electrode 5. The inner shaped opening of the casing 2 has several shoulders and has a seat for positioning the insulator 3 by means of a metal washer 1 (compensating ring) which makes it possible to achieve perfect contact between the casing 2 and the insulator 3, gas-tightness of the spark plug and good transfer of heat from the insulator 3 into the casing 2 and further into the head of the combustion engine. Near its edge, in the area of the threaded pin in the terminal cylindrical end, the opening of the casing 2 is reduced by the inner shoulder.

In the area of the hexagon 14 on the side opposite the spark gap of the spark plug, the casing 2 ends in a surface 9 basically perpendicular to the axis of the casing 2, from which, near the edge of the inner opening of the casing 2, the radial shoulder 8 of the triangular cross-section projects to a height of approximately 0.5 mm. After the casing 2 is placed on the insulator 3 assembly with through central electrode 5 in the assembly jig, the outer end of the casing 2 with radial shoulder 8 fits tightly against the bevelled shoulder of the ceramic insulator 3. The position of the casing 2 with respect to the insulator 3 is defined by the close fit of the inner shoulder of the casing 2, in the area of the tip of the insulator 3 over the metal washer 1 (compensating ring), on the corresponding opposite shoulder of the insulator 3.

In this position the sharp edge 12 of the pressing instrument 11 fits closely against the bevelled surface in the area of the base of the radial shoulder 8 of the casing 2 (FIG. 3), which is thus centred both with regard to the pressing instrument 11 and the ceramic insulator 3 inserted in the casing 2. Then, under pressure, the sharp edge 12 of the pressing instrument 11 penetrates the material of the front surface 9 of the casing 2 until a radial groove is formed in the front surface 9 of the casing 2, in the area of the base of the radial shoulder 8, whereby the radial projection 10 of the casing 2 is formed and at the same time, under the pressure of the obliquely shaped part of the radial sharp edge 12 of the pressing instrument 11, the downward pressure gradually increases from the outer side on the lateral wall of that projection 10, until that radial projection 10 bends across the shoulder of the ceramic insulator 3 in the direction of its axis, whereby the casing 2 is secured against the thrust on that end from the spark plug gap.

Electro-thermal assembly of the casing 2 follows, to ensure the tightness of the connection between the casing 2 and the insulator 3. Part 7 of the wall of the casing 2 is weakened and resistive heating of the casing 2 is carried out by passing an electric current into the casing 2 (in its weakened cross-section). By concurrent pressure in the axial direction between the beveled surface adjacent to the tip of the plug (in the area of the metal washer 1) and the outer part of the casing 2 in the area of the hexagon 14, deformation of the weakened part 7 of the wall of the casing 2 occurs with subsequent definition of the clearance of the spark plug assembly in the axial direction. After the heated, weakened wall of the casing 2 has cooled, the casing contracts in this place (in the axial direction) and the desired assembly bias occurs.

### INDUSTRIAL USE

The spark plug according to this invention is designed for ignition combustion engines.

1. A spark plug for a combustion engine, comprising a thermally and electrically conductive metal casing with attachment means, in the cavity of which there is a ceramic insulator with central electrode against which, to create the spark gap of the spark plug, there is arranged a lateral electrode fixed to the casing where, on the front surface of the outer end of the casing opposite the spark gap, near the edge of its inner opening, there is a radial shoulder adjacent to the corresponding outer shoulder of the insulator in order to fix their mutual positions and their mutual, gas-tight positioning on the opposite, inner end of the casing near the spark gap, characterised in that, in the area of the base of the radial shoulder, a radial groove is formed in the front surface of the outer end of the casing, making it possible to bend the projection with radial shoulder so formed in the direction of the axis of the spark plug, so that the camber of the bent projection above the front surface of the outer end of the casing is from 0 to 1 mm.

2. A spark plug according to claim 1, wherein the radial shoulder has a triangular cross-section about 0.3 to 0.6 mm in height with walls at an angle of 40 to 600, the size of the base being from 0.4 to 1 mm.

3. A spark plug according to claim 1, wherein the casing consists of a single integral part.

4. A method of securing the mutual positioning of the body of the ceramic insulator with through central electrode and the thermally and electrically conductive casing with lateral electrode of the spark plug, against the thrust of the body of the ceramic insulator from the cavity in the casing at its outer end, opposite the spark gap, by bending the radial shoulder on the front surface of the casing at its outer end into contact with the outer shoulder of the insulator, wherein, on the front surface of the casing at its outer end, a radial shoulder is formed at its inner opening, with at least a slanted outer lateral side, the slanted side is then subjected to pressure from the radial sharp edge of the pressing instrument, whereby the casing is centered with respect to the axis of the ceramic insulator inserted therein and with respect to the pressing instrument, and then pressure is exerted on the radial sharp edge of the pressing instrument until a radial groove is formed in the front surface of the casing, in the area of the base of the radial shoulder, whereby the radial projection of the casing is formed and at the same time, under the pressure of the obliquely shaped part of the radial sharp edge of the pressing instrument, the downward pressure gradually increases from the outer side on the lateral wall of that projection, until that radial projection bends across the shoulder of the ceramic insulator in the direction of its axis, whereby the casing is secured against the thrust on that end from the spark plug gap.

5. A method according to claim 4, wherein, after bending, the radial projection has a wall about 0.5 to 1 mm in length, ending in a triangular cross-section.
